(19) United States
(12) Patent Application Publication
(10) Pub. No.: US 2026/0220754 A1
(43) Pub. Date: Jul. 30, 2026

(54) A METHOD FOR EVALUATING THE QUALITY OF A DOCUMENT AND RELATED ELECTRONIC DEVICE

(71) Applicant: MAERSK A/S, Copenhagen K (DK)

(72) Inventors: Samrat DHAR, Mumbai (IN); Niranjan SENTHILVASAN, Neyveli (IN); Krishnakumar VENKATARAMAN, Charlottenlund (DK); Gaurav GRIGO, Copenhagen Ø (DK)

(21) Appl. No.: 19/148,643

(22) PCT Filed: Jan. 10, 2024
(86) PCT No.: PCT/DK2024/050003

§ 371 Date: Jul. 16, 2025

(30) Foreign Application Priority Data
Jan. 19, 2023 (DK) PA202370022

(51) Int. Cl. G06T 7/00

(52) U.S. Cl. CPC G06T 7/0002; G06T 2207/30168; G06T 2207/30176

(57) ABSTRACT

Disclosed is a method, performed by an electronic device, for evaluating a quality of a document. The method comprises obtaining textual data associated with the document. The method comprises determining a confidence score associated with at least one character of the plurality of characters by applying a quality prediction model to the textual data. The confidence score indicates how confident the quality prediction model is in matching the at least one character of with a pre-determined character. The method comprises determining, based on the confidence score associated with the at least one character, a document quality score associated with the document. The method comprises providing an output associated with the document quality score.

The present disclosure pertains to the field of image processing. The present disclosure relates to a method for evaluating the quality of a document and related electronic device.

### BACKGROUND

Physical documents are digitalized, for example scanned and imported onto electronic devices, to be further processed, e.g. for controlling one or more machines. However, the quality of the scanned document varies. Organisations often depend on high quality scans for certain documents, such as technical documents, etc. When a document scan has a low quality and the text is not legible, this can be problematic, e.g. especially for certain industrial applications. It can result in a waste of resources by unnecessarily processing a document that is of poor quality.

### SUMMARY

There is a need for an electronic device and a method that can provide an evaluation of the quality of a digitalized version of a document, e.g. prior to any further processing.

Accordingly, there is a need for an electronic device and a method for evaluating the quality of a document, which mitigate, alleviate, or address the shortcomings existing and may allow for more accurate, robust, and time-efficient evaluation of a quality of a document, e.g. a digital version of the document, and thereby enabling a more efficient further processing of the document.

Disclosed is a method, performed by an electronic device, for evaluating a quality of a document, e.g. of a digital document. The method comprises obtaining textual data associated with the document. The method comprises determining a confidence score associated with at least one character of the plurality of characters by applying a quality prediction model to the textual data. The confidence score indicates how confident the quality prediction model is in matching the at least one character of with a pre-determined character. The method comprises determining, based on the confidence score associated with the at least one character, a document quality score associated with the document. The method comprises providing an output associated with the document quality score.

Disclosed is an electronic device comprising memory circuitry, processor circuitry, and an interface, wherein the electronic device is configured to perform any of the methods according to the disclosed methods.

Disclosed is a computer readable storage medium storing one or more programs, the one or more programs comprising instructions, which when executed by an electronic device cause the electronic device to perform any of the methods according to the disclosed.

It is an advantage of the present disclosure that the disclosed electronic device and method provide a prediction of the quality of a document prior to any further processing of the document. For example, when the document is to be provided for further processing (e.g., OCR) then the present disclosure can avoid unnecessary processing of a document having a document quality score that is not satisfactory. In other words, documents of insufficient quality may be selected to not undergo further processing, potentially preventing waste of resources (e.g. time, power, and/or computational resources) that would otherwise be caused by carrying out further processing on poor quality documents. In another example, the disclosed technique can reduce wastage of resources at a photocopying/printing device by not printing in case the quality of the document is of insufficient quality. The disclosed technique leads to a control of the documents that is less error prone, more robust, time and resource-efficient, compared to conventional or manual handling.

Further, the disclosed technique allows predicting a document quality score that can be used to compare with a criterion that is adaptable to the domain and/or context of the document. For example, the disclosed technique can adapt to a technical field (such as documents for control of machinery) requiring more accuracy than other fields (such as documents for leisure). For example, the criterion can reflect the requirement for more accuracy. The disclosed technique allows adjusting the required quality to a criterion selected based on the field of application. The disclosed technique enables to provide the industry specific auto-calibration of settings of a machine (such as a scanner, printer, or other machinery) based on reference and/or target document quality score.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically an example process where the disclosed technique for evaluating a quality of a document is carried out by an example electronic device according to this disclosure,

FIGS. 2A-B are a flow-chart illustrating an example method, performed by an electronic device, for evaluating a quality of a document according to this disclosure, and

FIG. 3 is a block diagram illustrating an example electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A document disclosed herein may be seen as an electronic document, such as a document that can be processed by a computing device (e.g., by the electronic device disclosed herein). In some examples, the document is a digitalized document, such as a scanned document. For example, the document is obtained by a digitalization of a physical document. In some examples, the document may be a legal document, a technical document for controlling a technical machine, and/or any other type of document.

A quality of a document may be seen as a legibility of a document, such as a visual property and/or an optical property that allows legibility of the document. In this disclosure, the quality of the document is characterized by the document quality score. The document quality score may be seen as a parameter quantifying the quality of the document, such as a legibility of the document, a visual quality of the document, and/or an optical quality of the document.

A confidence score disclosed herein may be seen as a parameter that characterizes how confident the quality prediction model is in its output. A confidence score can be a number between 0 and 1 that represents the likelihood that the output of the quality prediction model is correct, e.g. with respect to a pre-determined character. In other words, the confidence score can show the probability of a character being detected correctly. For example, a higher confidence score indicates greater accuracy in quality prediction model results. For example, the confidence score associated with a character indicates how confident the quality prediction model is in matching the character with a pre-determined character, such as pre-determined character from a pre-determined library of characters. For example, when the character open bracket “(” is detected and compared to a “C” as a pre-determined character, the confidence score indicates how confident the quality prediction model is that the character “(” of the document is a “C”. For example, the quality prediction model is trained on identifying the difference between “(” or “C”. For example, when the character “(” is detected and can be identified either as “(” or as “C”, then the quality prediction model determines a lower confidence score for “C” than for “(”.

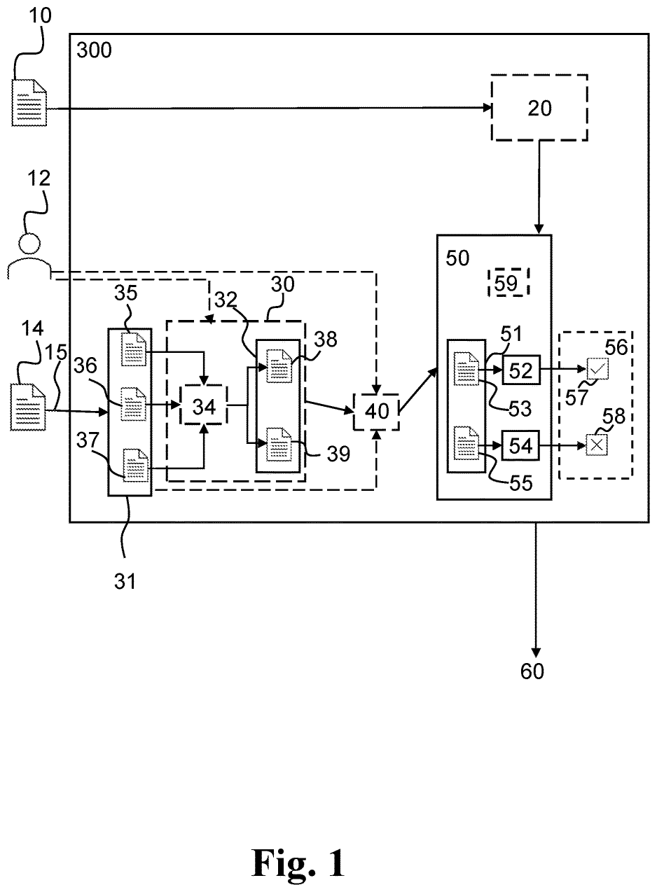

FIG. 1 is a diagram illustrating schematically an example process, such as an example electronic device 300 where the disclosed technique for evaluating a quality of a document is carried out according to this disclosure.

FIG. 1 shows an example electronic device 300. The electronic device 300 obtains textual data 15 associated with a document 14. Document 14 may be a digitalized version of a physical document. For example, the document 14 comprises one or more pages. For example, the one or more pages comprises a plurality of characters. For example, the textual data 15 includes data elements representative of respective characters of each of the one or more pages of the document 14. The data elements are for example associated with individual pixels representative of a corresponding character of the plurality of characters. In some examples, a data element can include values associated with the colour (e.g., shade of greyscale) of a pixel representative of a corresponding character of the plurality of characters, and/or coordinates of the pixel. The textual data can include data associated with an image and/or a drawing of the document.

In some examples, document 14 comprises a first page 35, a second page 36 and/or an Nth page(s) 37, where N is a positive integer. Document 14 may comprise a third page 38 and a fourth page 39. For example, the third page 38 and/or the fourth page 39 may the same as the first page 35, the second page 36 and/or the Nth page(s) 37.

The electronic device 300 for example is configured to execute a quality prediction model 50. The electronic device 300 for example is configured to optionally run a quality threshold model 20, a page pool identifier 30 and/or a page selector 40.

In some examples, the quality prediction model 50 is operatively coupled with the quality threshold model 20, the page pool identifier 30 and/or the page selector 40.

The electronic device 300 determines a confidence score associated with at least one character of the plurality of characters by applying the quality prediction model 50 to the textual data 15. The confidence score indicates how confident the quality prediction model is in matching the at least one character with a pre-determined character. For example, confidence score 52 is associated with at least one character, such a character of a given page, such as page 51. For example, confidence score 54 is associated with at least one character, such a character of a given page, such as page 55.

The electronic device 300 determines, based on the confidence score 52, 54 associated with the at least one character, a document quality score associated with the document.

The electronic device 300 provides an output 60 associated with the document quality score. The output 60 can be used for indicating whether the document quality score shows a satisfactory quality for an industrial application or not. The output 60 can be used to control a machine, e.g. for a re-digitalization of a part of the document, and/or for storing the document quality score together with the document. The output 60 can be in form of user interface object displayed to assist a user 12 in performing a technical task for controlling a machine, such as a scanner.

In some examples, the electronic device 300 determines whether to activate the page pool identifier 30 based on user input provided by the user 12. For example, the electronic device 300 may be configured to evaluate the quality of the entire document 14 (e.g., all pages of the document). In some examples, the page pool identifier 30 is configured to extract (e.g. import) the one or more pages of the document 14 (such as the first page 35, a second page 36 and/or an Nth page(s) 37). The one or more pages of the document 14 for example comprise one or more blank pages (such as not comprising at least one character) and/or one or more pages that are not fully filled with text, and/or pages with text (such as fully filled with text). The page pool identifier can be seen as a filter that can disregard pages that are blank or that do not include sufficient black pixels when compared to a criterion.

For example, in a document, not all the pages are fully filled with texts. For example, some pages are blank, and some are not. For example, some pages have only the first 2 lines filled, and the rest of the page is blank. For example, some pages have half-filled, and the rest of the page is blank. It may be appreciated that the disclosed electronic device can intelligently create a subset of optimal pages.

In some examples, the electronic device 300 (e.g. via the page pool identifier 30) may determine for at least one page (such as for each page), a page parameter indicative of a text quantity of a page, or indicative of a black pixel quantity of a page. In some examples, the electronic device 300 (e.g. via the page pool identifier 30) may determine, for each page, whether the page parameter satisfies a second criterion and provide a set 32 of pages comprising one or more pages having a page parameter satisfying the second criterion. The second criterion may be based on a second threshold.

The page pool identifier 30 may be based on a dilation model 34. The dilation model 34 is for example configured to perform a dilation technique. In some examples, the dilation model 34 is configured to measure (e.g., determine and/or quantify) the quantity of text (e.g., black pixels) in one or more pages of the document 14 (e.g., the first page 35, second page 36 and/or the Nth page(s) 37). The page pool identifier 30 via the dilation technique may determine the area (e.g., width×length, and/or a coordinate) of a page of the document 14 group (e.g., group into rectangular areas) one or more adjacent text areas (e.g., area comprising black pixels) of a page of the document 14. For example, the dilation model 34 may group one or more adjacent areas of textual data of a page of document 14. In other words, the dilation model 34 may group one or more adjacent text areas (e.g., area comprising black pixels) into one or more rectangles defining the area of contents (e.g., text). In some examples, the total area of the grouped text areas of a page of the document 14 may then be calculated using the dilation model. For example, a blank page may comprise a small number of black pixels, so total area of the grouped text areas would be small.

In some examples, the electronic device 300 may determine the page parameter of a specific page of the document 14 as a value indicative of the total area of the group text areas of a page of the document 14. In some examples, the page parameter of a specific page of the document is a ratio of the total area of the grouped text areas of a page of the document 14 to the total area of that page.

In some examples, the electronic device 300 may be configured to obtain colour pages. In some examples, the electronic device 300 may be configured to convert the colour pages into black and white (e.g., greyscale) pages. In some examples, the page pool identifier 30 may be configured to convert the colour pages into black and white (e.g., greyscale) pages. The page pool identifier 30 may provide converted pages (e.g., converted from colour to black and white) to the dilation model 34. The dilation model 34 may perform the dilation technique on the converted pages.

In some examples, the page pool identifier 30 is configured to determine, for each page of the document 14 (e.g., the first page 35, second page 36 and/or the Nth page(s) 37), a page parameter indicative of a text quantity of a page. The page parameter may be an integer, a fraction and/or a decimal. For example, the text quantity is indicative of the quantity of text of a page of document 14.

In some examples, the page pool identifier 30 is configured to determine, for each page, whether the page parameter satisfies the second criterion. The second criterion is for example based on a second threshold. The second threshold is for example a positive integer and/or a percentage (such as 30%, 50%). In some examples, the second threshold is provided by the user 12. For example, the second criterion is associated with the quantity of text (or black pixels) appearing in a page of document 14. In some examples, the page pool identifier 30 is configured to determine a proportion (e.g., a percentage) of the pages with the least text of the one or more pages of document 14. For example, the page pool identifier 30 may be configured to determine pages of the document 14 that are more than 50% filled (e.g. less than 50% blank). For example, a blank page can be seen as comprising a small number of black pixels (e.g., text). In other words, the second threshold can be updated based on the domain of industrial application.

For example, the page pool identifier 30 (e.g., the dilation model 34) is configured to identify one or more blank pages of the one or more pages of document 14, e.g. for disregarding blank pages, for resource efficiency. For example, when the page parameter of a page of the document 14 does not satisfy the second criterion, the page may be seen as blank, and not selected in the set 32 of pages to be provided. In some examples, the page pool identifier 30 is configured to provide the set of pages 32 including page 38 and/or 39. In some examples, the set 32 of pages comprises non-blank (such as pages comprising sufficient text required to satisfy the second criterion) pages of document 14. For example, the page pool identifier 30 refrains from including blank pages in the set 32 of pages. For example, the set of pages 32 comprises pages of the document 14 which satisfy the second criterion. In other words, the page pool identifier may provide a set of pages 32 comprising non-blank pages.

Advantageously, as an example, by excluding blank pages (e.g., only including sufficiently filled pages) in the set of pages 32, the overall processing time required for the quality prediction model 50 is reduced.

In some examples, the electronic device 300 comprises a page selector 40. The page selector 40 may be activated by the electronic device, on any occasion, e.g. even when the page pool identifier 30 is not activated. The page selector 40 is for example configured to obtain each page of the set 32 of pages (e.g., third page 38 and/or fourth page 39). In some examples, the page selector 40 is configured to select one or more pages of the document 14, such as one or more pages of the set of pages 32 when the page pool identifier 30 is activated. In some examples, the selection of the one or more pages is based on a selection parameter, such as a percentage of the pages obtained. In some examples, the page selector 40 may be configured to randomly select a percentage (e.g., selection parameter=50%) of the pages of the set of pages 32. For example, the page selector 40 may be configured to determine a percentage of pages of the set of pages 31 to select based on user input provided by the user 12. For example, the page selector 40 may be configured to select pages randomly (e.g., using a random number generator). For example, when the document 14 is a legal document (e.g., a contract), the page selector 40 may be configured (e.g., based on user input from the user 12) to select 100% of the pages of the set of pages 31 (e.g. selection parameter=100%). In some examples, the page selector 40 can be skipped based on user input provided by user 12.

In some examples, the quality prediction model 50 (e.g. a page quality predictor) obtains a set 51 of pages. The set 51 may comprise one or more pages of the set of pages 32 selected by the page selector 40. In some examples, the page selector 40 is configured to provide the set 51 of pages to the quality prediction model 50. The set 51 of pages for example comprises a first page 53 and/or a second page 55. The first page 53 and/or second selected page 55 may be pages of document 14. In some examples, the first page 53 is the same as the third page 38. In some examples, the second page 55 is the same as the fourth page 39. In some examples, the quality prediction model 50 takes as input the set 51 of pages from the page pool identifier 30.

In some examples, the quality prediction model 50 can be seen as a quality detection model. The quality prediction model 50 may be based on a pre-determined library 59 of characters including pre-determined characters. In some examples, the electronic device 300 is configured to obtain, based on the textual data of document 14, a pre-determined library 59 of characters. For example, the pre-determined library 59 of characters comprises one or more pre-determined characters. The pre-determined library 59 can be seen as a template character library. In some examples, the one or more pre-determined characters of the pre-determined library 59 comprises variations of characters. For example, the pre-determined library comprises variations of characters such as cursive, italic, bold, upper-case, lower-case, etc. The pre-determined library can include characters from any alphabet, and/or any special character, and/or other types. The pre-determined library can be based on a language of interest and any associated characters.

In some examples, the quality prediction model 50 may be based on a neural network. In some examples, the quality prediction model 50 is based on one or more of: Artificial Neural Networks (ANN), Convolution Neural Networks (CNN), Recurrent Neural Networks (RNN), and a Long Short Term Memory (LSTM) model. The quality prediction model 50 can be based on any model used to identify the characters along with the confidence score. In some examples, the neural network of quality prediction model 50 is based on a (LSTM). In some examples, training the quality prediction model 50 comprises applying a (LSTM) model. In some examples, the quality prediction model 50 is trained based on textual training data and one or more pre-determined characters of more pre-determined libraries. For example, the quality prediction model 50 is trained based on variations of characters such as cursive, italic, bold, upper-case, lower-case, etc. In some examples, training the quality prediction model 50 comprises applying a neural network model configured to identify characters (e.g., in comparison with pre-determined characters). For example, the neural network model may be configured to identify characters of the training documents based on characters of one or more pre-determined libraries.

For example, the textual data of the first page 53 and/or the second page 55 is obtained by scanning the document 14. In some examples, the quality prediction model 50 is configured to determine a confidence score associated with at least one character of the plurality of characters. In some examples, the quality prediction model 50 is configured to determine, based on the textual data and a pre-determined library of characters, the confidence score associated with at least one character of document 14. For example, the quality prediction model 50 determines the confidence score associated with each character of document 14, based on the textual data and a pre-determined library of characters. In some examples, the quality prediction model 50 is configured to determine a confidence score associated with one or more characters of the first page 53 and/or of the second page 55 of the set 51. For example, the quality prediction model 50 is configured to determine a confidence score associated with each character of the first page 53 and/or the second page 55 of the set 51.

For example, the confidence score indicates how confident the quality prediction model 50 is in matching at least one character of document 14 (e.g., of the first page 53 and/or the second page 53) with a character of the pre-determined library. For example, the character of the pre-determined library can be seen as the pre-determined character. In other words, the quality prediction model 50 is configured to determine a confidence score indicative of a probability of how confident the model 50 is in associating a character of the textual data to a pre-determined character, e.g. how confident that the at least one character of the plurality of characters is the same as the pre-determined character. The confidence score is for example a percentage. For example, when textual data indicative of the character “C” is obtained, the quality prediction model 50 may be configured to determine, based on the textual data and a pre-determined library of characters, a confidence score indicative of a probability of how confident the association of the character detected as “C” is with the character ‘C’ of the pre-determined library. For example, the quality prediction model 50 may interpret the character of open bracket ‘(’ as a C with a confidence score lower than the confidence score associated with an open bracket.

In some examples, the confidence score associated with a character may differ depending if the character is blurred and/or has a luminosity effect on it. For example, the quality prediction model 50 may determine a lower confidence score for a blurry character than for a clear character. For example, the quality prediction model 50 may determine a lower confidence score for character with a luminosity effect than for a character without a luminosity effect. For example, a is given a higher confidence score than for a.

In some examples, confidence scores can be generated for all the characters of the pages (e.g., first page 53 and/or second page 55).

In some examples, the quality prediction model 50 is configured to group the confidence scores. For example, grouping the confidence scores comprises grouping similar and/or identical confidence scores together in a confidence group. In some examples, the confidence group of similar and/or identical confidence scores can be seen as a zone. In some examples, a page of the set 51 can be seen as comprising one or more confidence groups (e.g., zones). For example, a page of document 14 may be partially obscured and/or affected by a shadow and/or artifact covering an area of the page. The page of document 14 may comprise areas and/or zones of low confidence score and areas and/or zones of high confidence score. The covered (e.g., shaded) area may be seen as an area of the page comprising characters associated with a lower confidence score in comparison with the unshaded area of the page. In some examples, the quality prediction model 50 is configured to determine the number of characters in each confidence group (e.g., characters with similar and/or identical confidence scores). In some examples, the confidence group and/or zone can be seen as an area of a page (e.g., such as a page of the set of selected pages 51) of the document 14.

In some examples, the electronic device 300 determines the document quality score based on the confidence scores. In some examples, the electronic device 300 is configured to determine, based on the page quality score of one or more pages of the document 14 (e.g., one or more pages of the selected set of pages 51), the document quality score. For example, the document quality score is determined based on page quality scores of one or more pages of the document, such as based on a statistical metric using the page quality scores (e.g. an average, a weighted average, a median, a mean across the one or more pages of the document). In some examples, determining the document quality score comprises averaging (e.g., calculating the average of) the page quality scores (such as the page quality score for each page of the selected set of pages 51 of document 14) over the number of pages.

For example, the electronic device determines a page quality score based on a weighted mean of the one or more confidence groups of the page (e.g., first page 53 and/or second page 55). In some examples, the electronic device takes the weighted mean of the one or more groups and/or zones and derives a page quality score of the page (e.g., a page of the set of selected pages 51). The size (such as the number of characters) of a group and/or zone may be used to determine the page quality score.

For example, the page quality score for a page can be expressed as e.g.:

$$S = \frac{{\sum }_{i = 1}^{n} {w}_{i} {x}_{i}}{{\sum }_{i = 1}^{n} {w}_{i}} \qquad ( 1 )$$

Where S denotes a page quality score, widenotes a number of characters in confidence group i in the page, Xᵢ denotes the confidence score associated with the confidence group i in the page. For example, confidence scores can be derived for the characters of a page, and can be grouped in 2 confidence groups: confidence Group 1 with 90% confidence score, and confidence Group 2 with 40% confidence score. The confidence Group 1 includes 2 counts of characters, and the confidence Group 2 includes 3 counts of characters. The page quality score in this example can be expressed as: (2*90+3*40)/(2+3)=60%.

In some examples, the electronic device 300 is configured to determine whether the document quality score satisfies a first criterion. The first criterion is for example based on a first threshold. For example, as illustrated in 57, the document quality score satisfies the first criterion when the document quality score is equal or greater than or less than the first threshold.

In some examples, the electronic device 300 provides an output 60 indicating that the document quality score meets the first criterion, when the document quality score satisfies the first criterion. For example, when the document quality score is less than the first threshold, the document quality score does not satisfy the first criterion, as illustrated in 58. In some examples, the electronic device 300 provide an output 60 indicating that the document quality score does not satisfy the first criterion, when the document quality score does not satisfy the first threshold. For example, a document with a document quality score meeting the first criterion may be seen as a good quality document (e.g., above the good quality standard and/or par).

In some examples, a quality threshold model 20 is configured to provide a first criterion, such as a first threshold used to determine whether the document quality score meets the first criterion. In some examples, the first threshold may be determined based on the document quality scores of the one or more training documents 10. This is advantageous to characterize the criterion needed for an industrial application.

The quality threshold model 20 for example obtains textual training data associated with one or more training documents 10. In some examples, the textual training data is data for determining the first threshold for a set of training documents. In some examples, the one or more training documents 10 comprise pages with clearly legible text (e.g., good quality text). In some examples, the quality threshold model 20 is configured to determine a first threshold based on the textual training data of the one or more training documents 10. In other words, the textual training data obtained from the training documents 10 may be used to determine the first threshold (e.g., a numeric threshold). The first threshold can be seen as a threshold for defining whether the document 14 is good quality.

For example, the need and/or requirement for accuracy of the document 14 (e.g., such as quality) may depend on the domain of application for the document 14. For example, more technical domains (e.g., such as science and/or law) may require document 14 to be high accuracy. In other words, for technical domains, the first threshold for may be high. For example, non-technical domains (such as leisure and/or fiction) may not require document 14 to be high accuracy. In other words, for less technical domains the threshold may be lower than for more technical domains. In some examples, the one or more training documents 10 may be of the same domain of document 14.

In some examples, the one or more training documents 10 comprise one or more zones (e.g., groups) associated with a particular confidence score of the characters of the one or more training documents 10 to allow training of the quality threshold model 20.

The output 60 of the electronic device can be used to accept or reject documents for further processing.

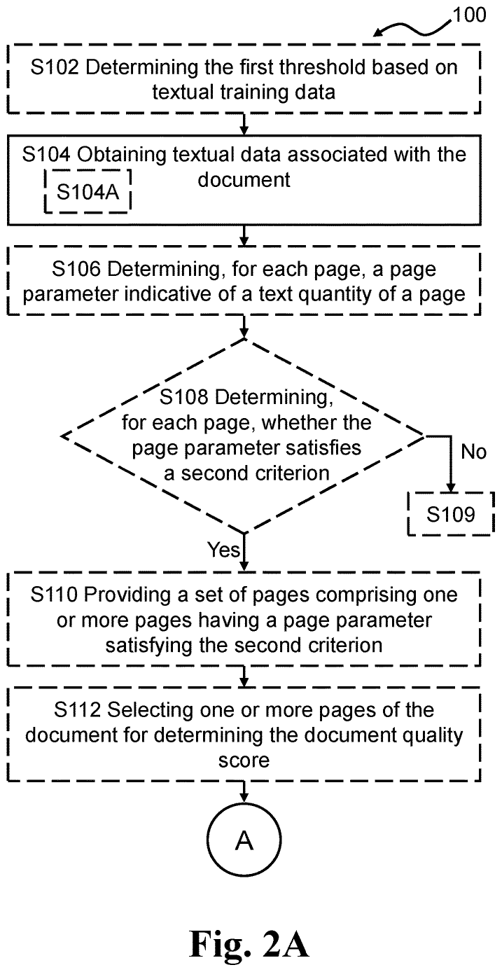

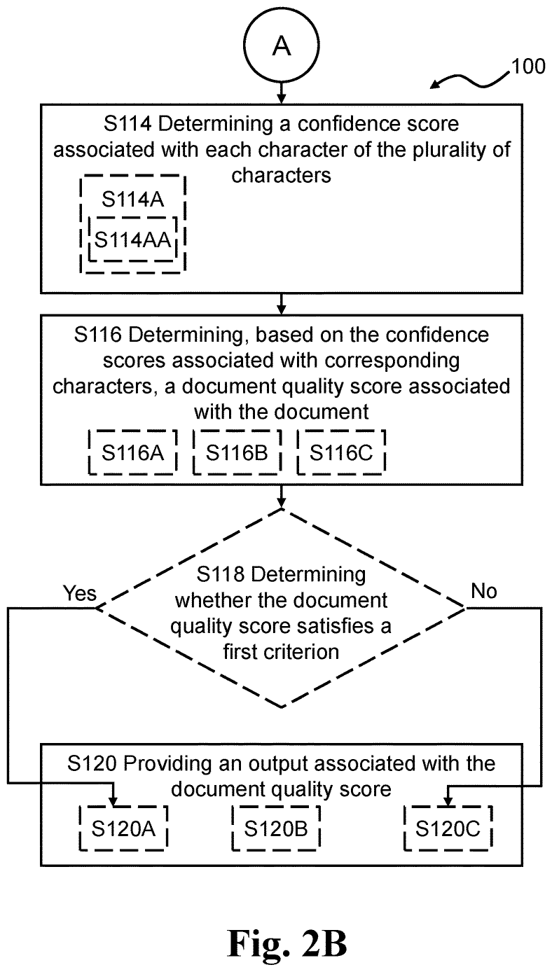

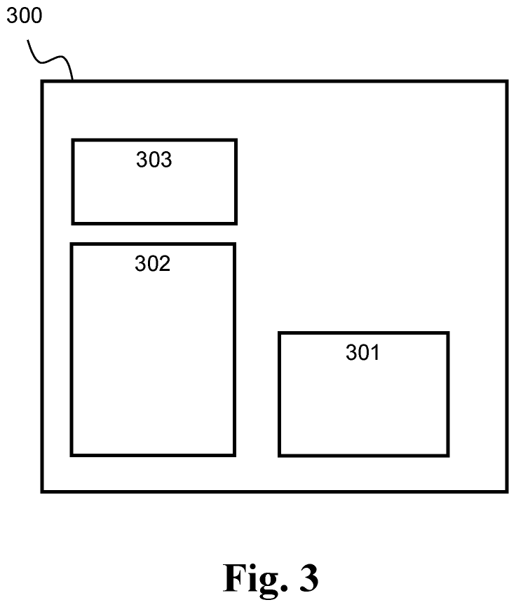

FIGS. 2A-B show a flow diagram of an example method, performed by an electronic device, for evaluating a quality of a document according to the disclosure. The method 100 can be performed for providing a document quality score of a document. The method 100 is performed by an electronic device, such as the electronic device disclosed herein, such as electronic device 300 of FIG. 1 and FIG. 3.

The method 100 comprises obtaining S104 textual data associated with the document. In some examples, the textual data includes alphanumeric data and/or data from a drawing and/or an image in the document. Textual data may be seen as document data, e.g. data associated with a document. The document comprises one or more pages. The one or more pages comprise a plurality of characters. In one or more example methods, obtaining S104 the textual data comprises converting S104A the document into textual data. In some examples, converting S104A the document into textual data comprises scanning the one or more pages of the document (e.g., using a scanning device). In one or more example methods, the method comprises obtaining colour pages. In some examples, converting the document into textual data comprises converting (e.g., using the page pool identifier 30 of FIG. 1) the colour pages into black and white (e.g., greyscale) pages. In some examples, the electronic device provides converted pages (e.g., converted from colour to black and white) to the page pool identifier (e.g., dilation model 34 of FIG. 1) and/or to the quality prediction model of FIG. 1.

In some examples, the textual data associated with the document comprises data elements representative of a corresponding character of the plurality of characters of the document. The data elements are for example individual pixels representative of a corresponding character of the plurality of characters. In some examples, the data elements are values associated with the colour (e.g., shade of greyscale) of a pixel representative of a corresponding character of the plurality of characters.

The method 100 comprises determining S114 a confidence score associated with at least one character of the plurality of characters. The confidence score indicates how confident the quality prediction model is in matching the at least one character with a pre-determined character. For example, the confidence score can be determined by applying S114A a quality prediction model to the textual data, such as by applying the quality prediction model to the at least one character of the textual data. In some examples, the quality prediction model is configured to predict a confidence score (e.g., a character confidence score) based on the textual data. In some examples, determining S114 a confidence score associated with the at least one character comprises determining two confidence scores associated with at least two respective characters by applying to the at least two characters of the textual data. In some examples, determining S114 a confidence score associated with the at least one character comprises determining confidence scores associated with less than all respective characters of the textual by applying to less than all the characters of the textual data. In some examples, determining S114 the confidence score comprises determining each confidence score associated with each character by applying to the textual data. For example, each confidence score associated with each character is determined by applying the quality prediction model (e.g., quality prediction model 50 of FIG. 1) to each character of the textual data. In one or more example methods, the quality prediction model is configured to determine, based on the textual data, the confidence score associated with each character of the plurality of characters.

In one or more example methods, the quality prediction model is configured to determine, based on the textual data and a pre-determined library of characters, the confidence score. In one or more example methods, applying S114A the quality prediction model comprises comparing S114AA the at least one character to the pre-determined character from the pre-determined library of characters. In one or more example methods, applying S114A the quality prediction model comprises comparing S114AA each character to the pre-determined character from the pre-determined library of characters. In some examples, applying S114A the quality prediction model comprises obtaining the pre-determined library. In some examples, the method 100 comprises selecting a pre-determined library based on the document. In some examples, the pre-determined library may comprise characters of one or more languages. For example, the pre-determined library may comprise English, German, Russian. Arabic, etc. characters. In some examples, applying the quality prediction model comprises selecting, based on the textual data associated with the document, a pre-determined library comprising pre-determined characters of an appropriate language (e.g., such as a pre-determined library comprising characters of the same language of the document).

In one or more example methods, the quality prediction model comprises a neural network. The quality prediction model can be based on any model capable of recognizing a character. In one or more example methods, the neural network is based on one or more: an Artificial Neural Network (ANN), a Convolutional Neural Network (CNN), a Recurrent Neural Network (RNN), and a Long Short Term Memory (LSTM) model.

A CNN may be seen as a neural network, including an input layer with one or more input nodes for the textual data, a hidden layer with one or more hidden nodes, and an output layer with one or more output nodes for determining the confidence score, and learnable weights associated with each node. The hidden layer may be seen as a convolutional layer configured to perform convolutions for providing a character and its associated confidence score.

A RNN may be seen as neural network where connections between nodes can create a cycle, allowing output from some nodes to affect subsequent input to the same nodes. Examples of RNNs include a feed-forward neural networks and/or an LSTM model.

The LSTM model may be seen as a recurrent neural network capable of learning order dependence in sequence prediction and can include one or more neural networks and numerous memory blocks, or cells, that can form a chain. The LSTM model may execute using sequences of data of varying input length and has one or more functions, such as classification, and/or regression for character or quality prediction.

The method 100 comprises determining S116, based on the confidence score associated with the at least one character, a document quality score associated with the document. In one or more example methods, determining S116 the document quality score comprises determining S116A, based on the confidence score associated with the at least one character of the plurality of characters of a page, a page quality score for the page of the document. In one or more example methods, determining S116 the document quality score comprises determining S116B, based on the page quality score of one or more pages of the document, the document quality score. In some examples, determining, based on the page quality score of one or more pages of the document, the document quality score comprises determining, based on the page quality score, a statistical metric of one or more pages of the document. In some examples, the statistical metric may be an average, a weighted average, and/or a median, etc.

In some examples, the document quality score of the document is determined based on the confidence scores associated with each character of the document. For example, the page quality score of the page is determined based on the respective confidence score associated with each character of the page. The document may include pages and the document quality score is derived based on the page quality scores of each pages of the document.

The method 100 comprises providing S120 an output associated with the document quality score. In some examples, providing S120 the output comprises providing, based on the confidence score, an output associated with the document quality score.

In one or more example methods, the method 100 comprises determining S118 whether the document quality score satisfies a first criterion. The first criterion may be a criterion set for filtering the document for further processing. For example, a document not meeting the first criterion can be disregarded for further processing and/or control of a machine.

In some examples, providing S120 the output associated with the document quality score comprises providing the output indicative of whether the document quality score satisfies the first criterion. In one or more example methods, the method comprises, in accordance with a determination that the document quality score satisfies the first criterion, providing an output indicative of the document quality score satisfying the first criterion. In one or more example methods, the method comprises, in accordance with a determination that the document quality score does not satisfy the first criterion, providing an output not indicative of the document quality score satisfying the first criterion. In one or more example methods, providing S120 the output comprises providing S120A an output indicating that the document quality score meets the first criterion, in accordance with a determination that the document quality score satisfies the first criterion. In one or more example methods, providing S120 the output comprises providing S120C an output indicating that the document quality score does not meet the first criterion in accordance with a determination that the document quality score does not satisfy the first criterion. In one or more example methods, providing S120 an output associated with the document quality score comprises providing S120A an output indicating that the document quality score satisfies the first criterion. In one or more example methods, providing S120 an output associated with the document quality score comprises providing S120C an output indicating that the document quality score does not satisfy the first criterion.

In one or more example methods, the first criterion is based on a first threshold. In some examples, whether the document quality score satisfies the first criterion includes whether the document quality score is equal or greater than or less than the first threshold. For example, when the document quality score is equal or greater than the first threshold, the first criterion can be seen as being satisfied by the document quality score. For example, when the document quality score is less than the first threshold, the first criterion can be seen as not being satisfied by the document quality score.

In one or more example methods, the method 100 comprises determining S102 the first threshold based on textual training data associated with one or more training documents. This may be seen as an initialization step that can be done online or offline. In some examples, the textual training data is training alphanumeric data. In some examples, the one or more training documents comprise pages with a legible text (e.g., good quality text, a document seen as having acceptable quality). In some examples, the quality threshold model is configured to determine a first threshold based on the textual training data of the one or more training documents. It may be appreciated that the electronic device can determine whether a document is of enough quality according to the first threshold which may be based on good training documents provided for a given application. The quality of these training documents can be adjusted according to the desired quality of the document.

In one or more example methods, the method comprises determining S106, for each page, a page parameter indicative of a text quantity of a page. The disclosed technique may filter pages based on the quantity of text they comprise. Hence, the present disclosure may determine, and subsequently, filter out blank pages from being assessed for text quality. This may save time it is not resource and/or time efficient to assess blank pages of a document for text quality. In other words, the disclosed technique may determine a subset of pages of a document to be assessed, hence reducing the time taken to provide a prediction of the quality of the document.

In some examples, determining S106, for each page, a page parameter indicative of a text quantity of a page comprises applying a dilation model (e.g., dilation model 34 of FIG. 1). The dilation model may be configured to perform a dilation technique. Performing the dilation technique for example comprises creating a bounding box (e.g., a boundary) across (such as surrounding) the text (e.g., the entire black pixel) of a page. Performing the dilation technique for example reduces the noise and/or enables combination (e.g., grouping) of the adjacent (e.g., nearby) pixels. In other words, performing the dilation technique may comprise grouping the nearby lines of text together. The dilation model is for example configured to determine the area (e.g., width×length) of a page of the document. The dilation model may be configured to group one or more adjacent text areas together (e.g., grouping text into rectangular areas). A text area can for example be seen as a line of text (e.g., where the textual data is indicative of a line of text in document 14). In some examples, the total area of the text areas of a page of the document may then be calculated, for example by the page pool identifier. In some examples, the page parameter of a specific page of the document is a value indicative of the total area of the text areas of a page of the document. In some examples, the page parameter of a specific page of the document is a ratio of the total area of the text areas of a page of the document to the total area of that page. For example, determining the page parameter of each page comprises matching (e.g., comparing) the total text area of a page with the total area of the page.

For example, where the dimensions of a page of the document is 600×400 mm, the area will be 240000 mm². For example, where a page x of the document comprises a full page of text so the total dimensions of text of the page x would be 500×200 mm. So the area of text of page x would be 100000 mm². For example, a page y of the same document may comprise only two lines of text so it may comprise dimensions of only 10×200 mm (area of 2000 mm²) of text. The page pool identifier may be configured to sort these based on the area of text. For example, the page pool identifier may determine that the page with the highest area of text is the best candidate page (e.g., this page may be seen as a priority page). So, in this example, page x would be selected over page y. For example, the dilation model may be configured to sort the pages in order of quantity of text area and/or black/occupied pixels. In some examples, the page with the highest ratio of total text area to total page area may be seen as the best candidate. For example, the dilation model may be configured to sort the pages in order of highest ratio of total text area to total page area.

In one or more example methods, the method 100 comprises determining S108, for each page, whether the page parameter satisfies a second criterion. In one or more example methods, the second criterion is based on a second threshold. The second criterion may be seen as a criterion to filter out sufficiently blank pages, as illustrated in FIG. 1.

In one or more example methods, the method 100 comprises providing S110 a set of pages comprising one or more pages having a page parameter satisfying the second criterion. In one or more example methods, the set of pages comprising one or more pages having a page parameter satisfying the second criterion is provided in accordance with a determination that the page parameter satisfies the second criterion. criterion. In one or more example methods, the set of pages comprising one or more pages having a page parameter satisfying the second criterion is not provided in S109 in accordance with a determination that the page parameter does not meet the second criterion.

In some examples, the method 100 comprises, in accordance with a determination that the page parameter associated with a given page satisfies the second criterion, including the given page into a set of pages (e.g., the set of pages 32 of FIG. 1). In one or more example methods, selecting one or more pages of the document for determining the document quality score comprises selecting one or more pages of the set of pages using the page selector (e.g., page selector 40 of FIG. 1). In one or more example methods, determining the page quality score for a page of the document comprises determining a page quality score for a page of the set of pages (e.g., the set of pages 32 of FIG. 1).

In one or more example methods, the method 100 comprises selecting S112 one or more pages of the document for determining the document quality score. For example, selecting one or more pages of the document for determining the document quality score is carried out by the page selector (e.g., page selector 40 of FIG. 1). For example, selecting one or more pages of the document for determining the document quality score comprises selecting one or more pages of the set of pages (e.g., the set of pages 32 of FIG. 1) provided by the page pool identifier of FIG. 1 (e.g., the page pool identifier 30 of FIG. 1). In one or more example methods, determining S116, based on the page quality score of one or more pages of the document, the document quality score comprises determining S116C, based on the page quality score of the one or more selected pages of the document, the document quality score.

In one or more example methods, the selection of the one or more pages is based on a selection parameter. In some examples, the selection parameter can be provided by a user (such as the user 12 of FIG. 1). The selection parameter may be an arbitrary value (e.g., a positive integer). The selection parameter may be a percentage. In some examples, the page selector may (e.g., by default) randomly select 50% of the pages from the set of pages (e.g., the set of pages 32 of FIG. 1) provided by the page pool identifier. In some examples, the user (such as user 12 of FIG. 1) may provide (e.g., to the electronic device 300 of FIG. 1) a selection parameter (e.g., a percentage of pages to be provided to the quality prediction model 50). For example, when the domain of application of document 14 requires a high accuracy, the user may input a high value for the selection parameter (e.g., the user may provide the third threshold). For example, when document 14 is a legal contract, the user may provide a selection parameter of 100% (meaning, for example, that the set of pages 32 will comprise all pages of document 14). In one or more example methods, the selection parameter is based on a third threshold. In some examples, the third threshold can be provided by a user. The third threshold may be an arbitrary value (e.g., a positive integer). The third threshold may be a percentage for a quality requirement. Advantageously, the user can provide the selection parameter based on the type of document (e.g., the domain of application of the document). For example, when the document is a contract, the user may provide a selection parameter of 100%. In some examples, the user may provide information indicative of the type of document (e.g., a contract) which is to be evaluated to the electronic device. In some examples, the electronic device may store one or more specific selection parameters associated with one or more specific types of document (e.g., domains of application of a document). In other words, the electronic device may be configured to store a third threshold corresponding with each type of document. For example, when the electronic device obtains information indicative of the type of document (e.g., provided by the user), the electronic device (such as the page selector 40 of FIG. 1) may be configured to select a third threshold associated with the type of document (e.g., document 14 of FIG. 1). In other words, the selection model may be configured to update the selection parameter based on information, such as provided by the user, indicative of the type of document which is to be evaluated.

In one or more example methods, the quality prediction model is trained based on the textual training data associated with the one or more training documents. In some examples, the method comprises training the quality prediction model (such as a neural network, e.g. based on LSTM method) based on textual training data and one or more pre-determined characters of more pre-determined libraries. For example, the quality prediction model is trained on variations of characters such as cursive, italic, bold, upper-case, lower-case, etc.

In one or more example methods, the output is provided prior to further processing. In one or more examples, the further processing comprises Optical Character Recognition (OCR). For example, the disclosed method provides the output regarding the document quality score before performing Optical Character Recognition (OCR). Performing OCR is more valuable and results in less waste of resources when OCR is applied on documents that are deemed to be of satisfactory quality based on the output disclosed herein. The disclosed technique allows avoiding that OCR is carried out without knowing whether the result is going to be useful.

In one or more example methods, the method comprises providing S120 an output associated with the document quality score comprises controlling S120B the electronic device and/or an external device. In some examples, the method comprises storing the document and/or textual data together with the corresponding document quality score. In some examples, controlling the electronic device and/or an external device (e.g., an electronic device different to the electronic device 300 of FIG. 1 and FIG. 3). In some examples, the electronic device and/or the external device is a scanning device. In some examples, controlling the electronic device and/or the external device comprises controlling a scanning device. In some examples, controlling the electronic device and/or the external device comprises controlling, based on the output associated with the document quality score, the electronic device and/or the external device. For example, the method comprises updating, scanning parameters (such as exposure, contrast, sharpness) to improve the document quality score. For example, the method comprises, in accordance with a determination that the document quality score associated with the document does not satisfy the first criterion, updating the scanning parameters. For example, the method comprises, in accordance with a determination that the document quality score associated with the document satisfies the first criterion, refraining from updating the scanning parameters.

In some examples, controlling the electronic device and/or the external device comprises controlling image editing software. In some examples, controlling the electronic device and/or the external device comprises updating image parameters (such as exposure, contrast, sharpness) to improve the document quality score. For example, the method comprises, in accordance with a determination that the document quality score associated with the document does not satisfy the first criterion, updating the image parameters. For example, the method comprises, in accordance with a determination that the document quality score associated with the document satisfies the first criterion, refraining from updating the image parameters.

FIG. 3 shows a block diagram of an exemplary electronic device 300 according to the disclosure. The electronic device 300 comprises memory circuitry 301, processor circuitry 302, and an interface 303. The electronic device 300 is configured to perform any of the methods disclosed in FIGS. 2A-B. In other words, the electronic device 300 is configured for evaluating a quality of a document.

The electronic device 300 is configured to obtain (e.g., via memory circuitry 301, processor circuitry 302 and/or interface 303) textual data associated with the document.

The electronic device 300 is configured to determine (e.g., via processor circuitry 302) a confidence score associated with at least one character of the plurality of characters by applying (e.g., via memory circuitry 301 and/or processor circuitry 302) a quality prediction model to the textual data. The confidence score indicates how confident the quality prediction model is in matching the at least one character with a pre-determined character.

The electronic device 300 is configured to determine (e.g., processor circuitry 302), based on the confidence score associated with the at least one character, a document quality score associated with the document.

The electronic device 300 is configured to provide (e.g., via processor circuitry 302 and/or interface 303) an output associated with the document quality score.

The processor circuitry 302 is optionally configured to perform any of the operations disclosed in FIGS. 2A-B (such as any one or more of: S102, S104, S104A, S106, S108, S109, S110, S112, S114, S114A, S114AA, S116, S116A, S116B, S116C, S118, S120, S120A, S120B, S120C). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 3). The memory circuitry 301 is considered a non-transitory computer readable medium.

The memory circuitry 301 may be configured to store textual data, quality prediction model, quality threshold model, page pool identifier, page selector, textual training data, selection parameters, first criterion, second criterion, third criterion, first threshold, second threshold, third threshold, confidence scores, page quality scores, document quality scores, pre-determined library of characters, pre-determined characters, neural network, LSTM, document and/or one or more training documents a part of the memory.

Embodiments of methods and products (electronic device) according to the disclosure are set out in the following items:

Item 1. A method, performed by an electronic device, for evaluating a quality of a document, wherein the document comprises one or more pages, wherein the one or more pages comprise a plurality of characters, the method comprising:
obtaining textual data associated with the document;
determining a confidence score associated with at least one character of the plurality of characters by applying a quality prediction model to the textual data, wherein the confidence score indicates how confident the quality prediction model is in matching the at least one character with a pre-determined character;
determining, based on the confidence score associated with the at least one character a document quality score associated with the document; and
providing an output associated with the document quality score.

Item 2. The method according to item 1, wherein the quality prediction model is configured to determine, based on the textual data, the confidence score associated with each character of the plurality of characters.

Item 3. The method according to any of the previous items, wherein the quality prediction model is configured to determine the confidence score based on the textual data and a pre-determined library of characters.

Item 4. The method according to item 3, wherein applying the quality prediction model comprises comparing the at least one character to the pre-determined character from the pre-determined library of characters.

Item 5. The method according to any of the previous items, wherein the quality prediction model comprises a neural network, wherein the neural network is based on Long Short Term memory model.

Item 6. The method according to any of the previous items, wherein determining the document quality score comprises:
determining, based on the confidence score associated with the at least one character of the plurality of characters of a page, a page quality score for the page of the document; and
determining, based on the page quality score of one or more pages of the document, the document quality score.

Item 7. The method according to any of the previous items, wherein the method comprises selecting one or more pages of the document for determining the document quality score.

Item 8. The method according to items 6 and 7, wherein determining, based on the page quality score of one or more pages of the document, the document quality score comprises determining, based on the page quality score of the one or more selected pages of the document, the document quality score.

Item 9. The method according to any of items 7-8, wherein the selection of the one or more pages is based on a selection parameter.

Item 10. The method according to item 9, wherein the selection parameter is based on a third threshold.

Item 11. The method according to any of the previous items, wherein the method comprises determining whether the document quality score satisfies a first criterion.

Item 12. The method according to item 11, wherein the first criterion is based on a first threshold.

Item 13. The method according to item 12, wherein the method comprises determining the first threshold based on textual training data associated with one or more training documents.

Item 14. The method according to any of the previous items, wherein providing an output associated with the document quality score comprises providing an output indicative of whether the document quality score satisfies the first criterion.

Item 15. The method according to any of the previous items, wherein the method comprises:
determining, for each page, a page parameter indicative of a text quantity of a page;
determining, for each page, whether the page parameter satisfies a second criterion; and
providing a set of pages comprising one or more pages having a page parameter satisfying the second criterion.

Item 16. The method according to item 15, wherein the second criterion is based on a second threshold.

Item 17. The method according to any of the previous items, wherein obtaining the textual data comprises converting the document into textual data.

Item 18. The method according to any of items, 13-17, wherein the quality prediction model is trained based on the textual training data associated with the one or more training documents.

Item 19. The method according to any of the previous items, wherein the output is provided prior to further processing.

Item 20. The method according to any of the previous items, wherein providing an output associated with the document quality score comprises controlling the electronic device and/or an external device.

Item 21. An electronic device comprising memory circuitry, processor circuitry, and an interface, wherein the electronic device is configured to perform any of the methods according to any of items 1-20.

Item 22. A computer readable storage medium storing one or more programs, the one or more programs comprising instructions, which when executed by an electronic device cause the electronic device to perform any of the methods of items 1-20.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-3 comprise some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by an electronic device, for evaluating a quality of a document, wherein the document comprises one or more pages, wherein the one or more pages comprise a plurality of characters, the method comprising:
obtaining textual data associated with the document;
determining a confidence score associated with at least one character of the plurality of characters by applying a quality prediction model to the textual data, wherein the confidence score indicates how confident the quality prediction model is in matching the at least one character with a pre-determined character;
determining, based on the confidence score associated with the at least one character, a document quality score associated with the document; and
providing an output associated with the document quality score.

2. The method according to claim 1, wherein the quality prediction model is configured to determine, based on the textual data, the confidence score associated with each character of the plurality of characters.

3. The method according to claim 1, wherein the quality prediction model is configured to determine the confidence score based on the textual data and a pre-determined library of characters.

4. The method according to claim 3, wherein applying the quality prediction model comprises comparing the at least one character to the pre-determined character from the pre-determined library of characters.

5. The method according to claim 1, wherein the quality prediction model comprises a neural network, wherein the neural network is based on Long Short Term memory model.

6. The method according to claim 1, wherein determining the document quality score comprises:
determining, based on the confidence score associated with the at least one character of the plurality of characters of a page, a page quality score for the page of the document; and
determining, based on the page quality score of one or more pages of the document, the document quality score.

7. The method according to claim 1, wherein the method comprises selecting one or more pages of the document for determining the document quality score.

8. The method according to claim 1, wherein the method comprises determining whether the document quality score satisfies a first criterion.

9. The method according to claim 1, wherein the method comprises:
determining, for each page, a page parameter indicative of a text quantity of a page;
determining, for each page, whether the page parameter satisfies a second and criterion;
providing a set of pages comprising one or more pages having a page parameter satisfying the second criterion.

10. The method according to claim 1, wherein providing an output associated with the document quality score comprises controlling the electronic device and/or an external device.
